(19) United States
(12) Patent Application Publication
(10) Pub. No.: US 2020/0249540 A1
(43) Pub. Date: Aug. 6, 2020

(54) GROUND CAGE FOR AN INTEGRATED OPTICAL DEVICE

(71) Applicant: Elenion Technologies, LLC, New York, NY (US)

(72) Inventors: Daihyun Lim, Edgewater, NJ (US); Alexander Rylyakov, Staten Island, NY (US); Yangjin Ma, Brooklyn, NY (US)

(21) Appl. No.: 16/265,496

(22) Filed: Feb. 1, 2019

(51) Int. Cl. G02F 1/225

(52) U.S. Cl. CPC G02F 1/2255; G02F 2001/212

(57) ABSTRACT

A photonic chip including an integrated optoelectronic device is flip-chip mounted to a carrier. The optoelectronic device is provided with a 3D ground cage as a shield for stray EM radiation. The 3D ground cage is formed by a device ground electrode partially enclosing the optoelectronic device on a face of the chip, a carrier ground electrode disposed opposite to the device ground electrode, and a plurality of metal pillars therebetween at least partially surrounding the optoelectronic device. The optoelectronic device may be an OE converter of an integrated optical receiver. The optoelectronic device may also be an EO converter of an integrated optical transmitter.

### TECHNICAL FIELD

The present invention generally relates to components for optical communications, and more particularly relates to an integrated high-speed electro-optical transceiver device.

### BACKGROUND

Broad-band optical communications typically require high-speed optical transceivers capable of converting high data rate signals from optical to electrical domain in a receiver portion and from electrical to optical domain in a transmitter portion. A conventional optical transceiver may include an optical transmitter (Tx) chip and an optical receiver (Rx) chip mounted on a circuit board with driver and signal processing electronics. An optical Tx chip may include an electro-optical (EO) converter, typically an optical modulator such as a waveguide Mach Zehnder modulator (MZM) for devices operating in the GHz frequency range and beyond. An optical Rx chip may include one or more electro-optical (EO) converters, such as one or more photodetectors, for example in the form of PIN photodiodes.

### SUMMARY

An aspect of the present disclosure relates to an optical device comprising a photonic chip mounted to a carrier in a flip-chip manner, the photonic chip comprising an opto-electric device that is sensitive to electromagnetic (EM) interference, wherein the photonic chip and the carrier comprise ground electrodes connected with conducting pillars to form a 3D ground cage about the opto-electronic device to shield the opto-electronic device from the EM interference.

An aspect of the present disclosure relates to an optical transceiver comprising an EO signals converter, an OE signal converter, and a 3D ground cage configured to at least partially encase one of the EO signal converter or the OE signal converter for shielding the OE signal converter from stray RF radiation from the EO signal converter.

An aspect of the present disclosure relates to an optical transceiver comprising: a photonic chip comprising a photonic integrated circuit (PIC), the PIC comprising: an opto-electric (OE) signal converter, and a first PIC ground electrode at least partially surrounding the OE signal converter in a plane of the photonic chip. The optical transceiver further comprises a carrier to which the photonic chip is mounted with the PIC facing the carrier, the carrier comprising a first top ground electrode disposed opposite the first PIC ground electrode with a gap therebetween. The optical transceiver further comprises a first plurality of conducting pillars projecting from the main face of the photonic chip and electrically connecting the first PIC ground electrode to the first top ground electrode, the first plurality of conducting pillars arranged to form a fence configured to at least partially shield the OE signal converter from stray electromagnetic radiation in an operating frequency range of the optical transceiver

An aspect of the present disclosure relates to an optical transceiver comprising: a photonic chip comprising a main face and a photonic integrated circuit (PIC) disposed at the main face, the PIC comprising: a first optoelectronic device, and a first PIC ground electrode at least partially surrounding the first optoelectronic device at the main face of the photonic chip. The optical transceiver further comprises: a carrier to which the photonic chip is mounted, the carrier comprising a first top ground electrode disposed opposite the first PIC ground electrode with a gap therebetween; and, a first plurality of conducting pillars projecting from the main face of the photonic chip and electrically connecting the first PIC ground electrode to the first top ground electrode. The first plurality of conducting pillars may be arranged to form a fence configured to at least partially shield the first optoelectronic device from stray electromagnetic radiation in an operating frequency range of the optical transceiver.

### BRIEF DESCRIPTION OF THE DRAWINGS

Embodiments disclosed herein will be described in greater detail with reference to the accompanying drawings which represent preferred embodiments thereof, in which like elements are indicated with like reference numerals, and wherein:

FIG. 1A is a schematic plan view of a portion of a transceiver PIC chip showing an example electrode layout in transmit (Tx) and receive (Rx) portions of the chip with parallel Tx and Rx electrodes, and ground conducting pillars for EM isolation between an EO signal converter in the Tx portion and an OE signal converter in the Rx portion;

FIG. 1B is a schematic plan view of a portion of a transceiver PIC chip with ground conducting pillars fencing off the Rx portion from the Tx portion of the chip, and with orthogonally oriented Tx and Rx electrodes;

FIG. 2A is a schematic cross-sectional side view of a portion of the transceiver PIC chip of FIG. 1A or 1B mounted to a carrier with top ground electrodes to close EM isolation cages about the OE signal converter and/or the EO signal converter;

FIG. 2B is a schematic plan view of the carrier showing the top ground electrodes covering the OE signal converter and the EO signal converter for a PIC layout of FIG. 1A;

FIG. 2C is a schematic plan view of the carrier showing the top ground electrodes covering the OE signal converter and the EO signal converter for a PIC layout of FIG. 1B;

FIG. 2CD is a schematic plan view of the carrier showing the top ground electrodes and electrical signal pathways for a PIC layout of FIG. 1B;

FIG. 3A is a schematic perspective view of an EM isolation cage formed with an Rx outer ground electrode of the transceiver PIC chip, a top ground electrode of the carrier, and a succession of conducting pillars connected therebetween;

FIG. 3B is a schematic perspective view of an EM isolation cage formed with a Tx outer ground electrode of the transceiver PIC chip, a top ground electrode of the carrier, and a succession of conducting pillars connected therebetween;

FIG. 4A is a schematic cross-sectional side view of the portion of the transceiver PIC chip of FIG. 1A or FIG. 1B mounted to a carrier with a common top ground electrode enclosing the EM isolation cages about the OE signal converter and/or the EO signal converter;

FIG. 4B is a schematic plan view of the carrier showing the common top ground electrode of the carrier covering the OE signal converter and the EO signal converter;

FIG. 5A is a schematic plan view of a Tx portion of a transceiver PIC chip with separate Tx outer ground electrodes around two MZMs, and two sets of conducting pillars projecting from the respective Tx outer ground electrodes for separately encasing the MZMs;

FIG. 5B is a schematic plan view of the Tx portion of the transceiver PIC chip of FIG. 5A with the two Tx outer ground electrodes around two MZMs merged to form a common Tx outer ground electrode separately enclosing the MZMs in the plane of the PIC, and two sets of conducting pillars projecting from the respective Tx outer ground electrodes for separately encasing the MZMs;

FIG. 5C is a schematic plan view of the Tx portion of the transceiver PIC chip of FIG. 5B with a set of conducting pillars commonly encasing the MZMs;

FIG. 6A is a schematic plan view of an Rx portion of a transceiver PIC chip with a plurality of individually encaged PDs with a separate Rx ground electrode partially enclosing each PD, with different sets of conducting pillars fencing off each PD from an adjacent PD and a Tx portion of the chip;

FIG. 6B is a schematic plan view of the Rx portion of the transceiver PIC chip of FIG. 6A with the Rx outer ground electrodes merged to form a common Rx outer ground electrode separately enclosing the PDs in the plane of the PIC;

FIG. 6C is a schematic plan view of the Rx portion of the transceiver PIC chip of FIG. 6B with a set of conducting pillars commonly encasing the PDs within a same 3D isolation cage.

### DETAILED DESCRIPTION

In the following description, for purposes of explanation and not limitation, specific details are set forth, such as particular circuits, circuit components, techniques, etc. in order to provide a thorough understanding of the present invention. However, it will be apparent to one skilled in the art that the present invention may be practiced in other embodiments that depart from these specific details. In other instances, detailed descriptions of well-known methods, devices, and circuits are omitted so as not to obscure the description of the example embodiments. All statements herein reciting principles, aspects, and embodiments of the invention, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure. Thus, for example, it will be appreciated by those skilled in the art that block diagrams herein can represent conceptual views of illustrative circuitry embodying the principles of the technology.

Furthermore, the following abbreviations and acronyms may be used in the present document:

PIC Photonic Integrated Circuit

RF Radio Frequency

OSNR Optical Signal to Noise Ratio

ROSNR Receiver Optical Signal to Noise Ratio

BER Bit Error Rate

MZM Mach-Zehnder Modulator

MZI Mach-Zehnder Interferometer

PD Photo Detector

CMOS Complementary Metal-Oxide-Semiconductor

GaAs Gallium Arsenide

InP Indium Phosphide

SOI Silicon on Insulator

SiP Silicon Photonics

Note that as used herein, the terms “first”, “second” and so forth are not intended to imply sequential ordering, but rather are intended to distinguish one element from another, unless explicitly stated. Similarly, sequential ordering of method steps does not imply a sequential order of their execution, unless explicitly stated. The terms “connected”, “coupled”, and their variants are intended to encompass both direct connections and indirect connection through one or more intermediate elements, unless specifically stated otherwise. Radio frequency (RF) may refer to any frequency in the range from kilohertz (kHz) to hundreds of gigahertz (GHz).

One or more aspects of the present disclosure relates to an optical transceiver device having an electro-optic (EO) signal converter (EOSC) and opto-electric (OE) signal converter (OESC) implemented in a same photonic integrated circuit (PIC), and in at least some embodiments in a same photonic chip. For optical transceivers operating at high frequencies, e.g. in the 5-50 GHz range and beyond, electromagnetic (EM) crosstalk between the transmitter and the receiver, termed Tx-Rx crosstalk, may degrade the receiver sensitivity. The coupling of the transmitted signal into the receiver induces the receiver noise and bit-errors, and degrades the required optical signal-to-noise ratio (ROSNR). The Tx-Rx crosstalk becomes increasingly challenging as data rates increase and transceiver module sizes shrink. By way of example, at 20 GHz an EM crosstalk parameter S21 between contact pads of an EOSC and an OESC as low as −70 dB may noticeably degrade the receiver sensitivity and the receiver optical signal to noise ratio (ROSNR) at a given error rate.

Embodiments described herein provide a ground contact based Tx-Rx EM isolation scheme for a photonic chip with a transceiver PIC, wherein an OESC is provided with a 3D ground cage defined by one or more ground electrodes on a photonic chip, one or more ground electrodes on a carrier to which the photonic chip is mounted, and a plurality of conducting pillars, which may also be referred to as ground pillars, connecting the ground electrodes of the photonic chip and the carrier that are arranged to form an EM isolation fence between the EOSC and the OESC, and in some embodiments around at least one of the OESC and the EOSC. The OESC may include one or more photodetectors (PDs), and the EOSC may include one or more optical modulators such as but not exclusively MZMs. The photonic chip with the PIC may be flip-chip mounted to the carrier having one or more top ground electrodes disposed thereon facing the photonic chip. In some embodiments the 3D ground cage may be formed by an outer ground electrode disposed around the OESC or the EOSC on the photonic chip, the top ground electrode(s) of the carrier, and a plurality of conducting ground pillars projecting from the photonic chip at least partially surrounding the OESC or the EOSC and connecting the ground electrode(s) on the chip to the carrier ground electrode(s).

Embodiments described herein provide an optical transceiver comprising a photonic chip comprising a main face and a photonic integrated circuit (PIC) disposed at the main face. The PIC comprises a first optoelectronic device, and an a first PIC ground electrode at least partially surrounding the first optoelectronic device at the main face of the photonic chip. The optical transceiver further comprises a carrier to which the photonic chip is mounted, the carrier comprising a mounting face disposed facing the main face of the photonic chip, the mounting face carrier comprising a first top ground electrode disposed opposite the first PIC ground electrode with a gap therebetween. A first plurality of conducting pillars is provided, the pillars projecting from the main face of the photonic chip and electrically connecting the first PIC ground electrode to the first top ground electrode, the first plurality of conducting pillars arranged to form a fence configured to at least partially shield the first optoelectronic device from stray electromagnetic radiation in an operating frequency range of the optical transceiver.

In some implementations the first optoelectronic device may be an opto-electric (OE) signal converter. In some implementations the first optoelectronic device may be an opto-electric (OE) signal converter.

In some implementations the first plurality of conducting pillars may at least partially surround the first optoelectronic device in a plane parallel to the main face of the photonic chip.

In some implementations the first plurality of conducting pillars, the Rx ground electrode, and the first top ground electrode form a three-dimensional (3D) ground cage over the first optoelectronic device.

In some implementations the first optoelectronic device comprises a photodetector (PD) having a width at the main face of the photonic chip, and wherein the first plurality of conducting pillars comprises two pillars that are spaced apart by less than the width of the PD.

In some implementations the first plurality of conducting pillars comprises two pillars that are spaced apart by less than 500 μm.

In some implementations the first plurality of conducting pillars comprises two pillars that are spaced apart by at most half of a wavelength of an RF signal in the operating frequency range of the optical transceiver.

In some implementations the first top ground electrode at least covers the first optoelectronic device when viewed in a direction perpendicular to the main face of the photonic chip through the carrier.

In some implementations the first optoelectronic device comprises an opto-electric (OE) signal converter, and the PIC further comprises an electro-optic (EO) signal converter, and wherein the first plurality of conducting pillars is arranged to electromagnetically shield the OE signal converter from the EO signal converter.

In some implementations the first plurality of conducting pillars comprises at least two conducting pillars disposed along a portion of the OE signal converter facing the EO signal converter. In some implementations a second PIC ground electrode is provided that at least partially surrounds the EO signal converter at the main face of the chip.

In some implementations the mounting face of the carrier comprises a second top ground electrode disposed opposite to the second PIC ground electrode, the optical transceiver further comprising a second plurality of conducting pillars connecting the second PIC ground electrode to the second top ground electrode and arranged to shield the OE signal converter from the EO signal converter in the operating frequency range of the optical transceiver.

In some implementations the second plurality of conducting pillars at least partially surrounds the EO signal converter in a plane parallel to the main face of the photonic chip.

In some implementations the second plurality of conducting pillars, the second PIC ground electrode, and the second top ground electrode form a three-dimensional ground cage over the EO signal converter.

In some implementations the EO signal converter comprises an optical modulator having a width at the main face of the photonic chip, and wherein the second plurality of conducting pillars comprises two pillars that are spaced apart by less than the width of the optical modulator.

In some implementations the second plurality of conducting pillars comprises two pillars that are spaced apart by less than 500 μm. In some implementations the second top ground electrode at least covers the EO signal converter when viewed in a direction perpendicular to the main face of the photonic chip through the carrier.

In some implementations the first top ground electrode is separate from the second top ground electrode. In some implementations the first top ground electrode and the second top ground electrode are merged to form one top ground electrode.

In some implementations the optical transceiver comprises an insulating filler disposed between the carrier and the photonic chip and surrounding the conducting pillars. In some implementations the carrier comprises a low-temperature co-fired ceramic (LTCC).

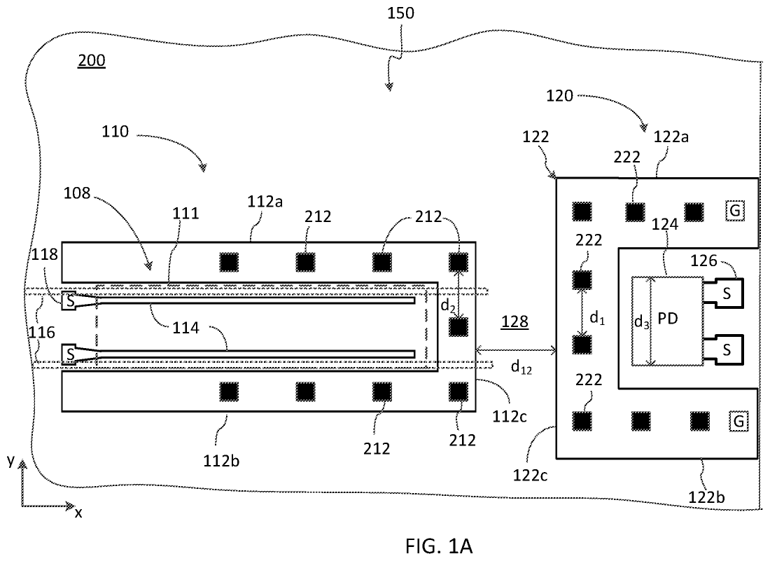

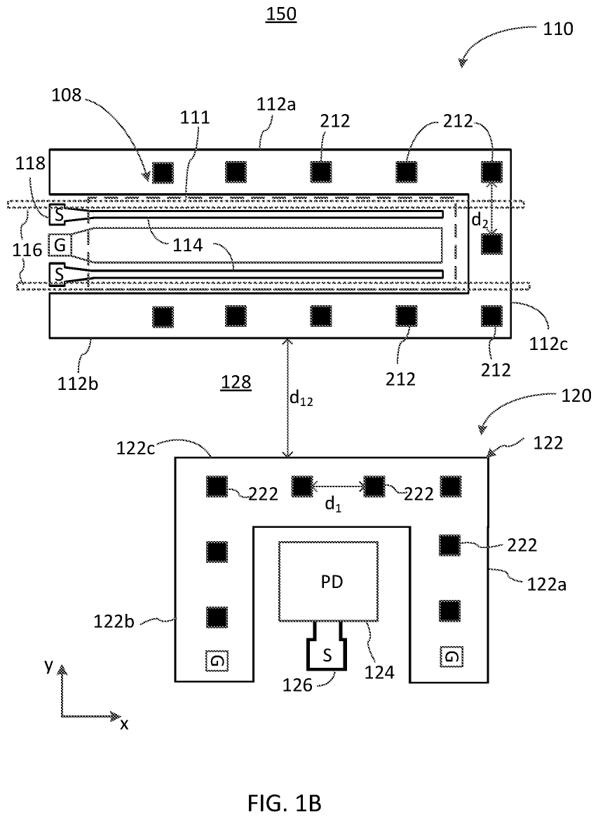

FIGS. 1A and 1B schematically illustrate two example layouts of a portion of a photonic integrated circuit (PIC) 150 according to some embodiments. PIC 150, which may be embodied in a photonic chip 200, may be used in an optical front-end of an optical transceiver configured to support bidirectional optical communications. PIC 150 includes a transmit (Tx) portion 110 and a receive (Rx) portion 120. The Tx portion 110 may be in the form of, or include, an EO signal converter (EOSC) 108, while the Rx portion may be in the form of, or include, an OE signal converter (OESC) 124. In order to reduce the size of the PIC, the OESC 124 may be positioned relatively close to the EOSC 108, for example at a distance of 0.5 millimeters (mm) or less, which may potential cause an undesirable RF signal coupling from the EOSC 108 into the OESC 124. In order to reduce this EM coupling, outer ground electrodes 122 and/or 112 may be provided around the OESC 124 and/or EOSC 108 with a fence of conducting pillars 222, 212 projecting therefrom to fence off the OESC 124 from the EOSC 108. The conducting pillars 222, 212 may also be referred to herein as the ground pillars or simply as pillars. The outer ground electrodes 122 and 112 may also be referred to as the first and second PIC ground electrodes.

In the illustrated embodiment the EOSC 108 includes an EO conversion region 111 and one or more signal electrodes 114 traversing the EO conversion region 111 along optical waveguides 116. The signal electrodes 114 are electrically coupled to the EO conversion region 111 so that an RF electrical signal applied to the signal electrodes 114 modulates an optical property of the optical waveguides 116. The optical waveguides 116 may represent, for example two arms of a waveguide MZI, in which case the EOSC 108 is an MZM. Signal contact pads 118 may be provided at an input end of the signal electrodes 114 for receiving the RF electrical signal. In some embodiments the signal electrodes 114 may form transmission lines along which the RF signal injected via the signal contact pads 118 propagates toward a termination at a distal end of the signal electrodes. In some embodiments only one signal electrode 114 may be provided, which may be disposed to modulate one or both of the optical waveguides 116. In some embodiments the signal electrode or electrodes 114 may be disposed alongside the waveguide arms 116 as illustrated in the figure. In some embodiments the signal electrode or electrodes 114 may be disposed over the optical waveguides 116. In some embodiments an additional ground electrode may be provided between the signal electrodes 114, as illustrated in FIG. 1B. In some embodiments four signal electrodes 114 may be provided so that each optical waveguide 116 is disposed between two signal electrodes 114 thereby enabling dual-differential modulation.

The EO conversion region 111 may be implemented in a variety of ways, depending in part on material properties of the photonic chips 200 and PIC 150. Generally PIC 150 may be implemented using semiconductor materials, dielectric materials, or a combination thereof. In some embodiments using semiconductor materials, the EO conversion region 111 may include one or more p/n junction that are located at least in part in the optical waveguides 116. In some embodiments these p/n junctions may be reverse-biased to form depletion-type optical phase modulators electrically coupled to the signal electrodes 114. In other embodiments an RF signal applied to the signal electrodes 114 may modulate light absorption in the optical waveguides 116, or modulate an effective refractive index of the optical waveguides through an electro-optic effect. In some embodiments the EO conversion region 111 may be in the form of, or include, a semiconductor-insulator-semiconductor capacitor (SiSCAP) structure. Other mechanisms by which an RF signal applied to the one or more signal electrodes 114 may modulate light propagating the optical waveguides 116 are also within the scope of the present disclosure.

A Tx ground electrode 112 may be disposed around the EO conversion region 111, at least partially surrounding it in the plane of the PIC. The Tx ground electrode 112, which may also be referred to as a Tx outer ground electrode or as a PIC ground electrode, may include two side ground electrode sections 112a and 112b that extend along the signal electrodes 114 on opposite sides of the EO conversion region 111, and a central ground electrode section 112c. The central ground electrode section 112c connects the two side ground electrode sections 112a and 112b at the distal ends of the signal electrodes 114, enclosing the signal electrodes 114 at their distal ends. In the embodiment illustrated in FIG. 1A, the central section 112c of the Tx ground electrode 112 is disposed between the EO conversion region 111 of the chip and the OESC 124 in the Rx portion of the chip 200. In some embodiments the side electrode sections 112a and 112b of the Tx ground electrode 112 may be electrically or electro-magnetically coupled to the signal electrodes 114, cooperating with the signal electrodes 114 to modulate an optical property of the optical waveguides 116 when an RF signal is applied to the signal electrodes 114.

The OESC 124 may be in the form of one or more photodetectors (PD), which in operation convert a received light signal or signal into an Rx electrical signal. The Rx electrical signal may be accessed using one or more PD signal electrodes 126, which may be for example in the form of PD contact pads. In the example embodiment illustrated in FIG. 1A, the OESC 124 has two signal electrodes 126 and may be in the form of a single PD configured for differential detection; it may also be in the form of two PDs configured for single-ended operation. In the example embodiment illustrated in FIG. 1B the OESC 124 has one PD signal electrode 126 and may be in the form of a single PD configured for single-ended operation.

A first PIC ground electrode 122, which may also be referred to herein as the Rx ground electrode 122, at least partially envelops or surrounds the OESC 124 in the plane of the PIC, encasing the OESC 124 at the Tx side to shield the OESC 124 from the EOSC 108 in the plane of the PIC. The Rx ground electrode 122 may also be referred to as an Rx outer ground electrode. A central section 122c of the Rx ground electrode 122 is disposed between the OESC 124 and the EOSC 108 to shield the OESC 124 from the EOSC 108 in the plane of the PIC. The Rx ground electrode 122 may further include two side sections 122a and 122b that are disposed to shield the OESC 124 at the sides thereof. In some embodiments the Rx ground electrode 122 may extend along at least half of the circumference of the OESC 124, or along about three quarters of the circumference of the OESC 124. Although FIGS. 1A and 1B show the Rx ground electrode 122 that is formed of three straight rectangular electrode segments connected at 90 degrees, that is not a requirement, and the Rx ground electrode 122 may be of any suitable shape to shield the OESC 124 from the EOSC 108 in the plane of the chip.

The Tx and Rx outer ground electrodes 112, 122 may be separated in the plane of the chip 200 by a Tx-Rx gap 128 of a width d₁₂. By way of example the Tx-Rx gap width d₁₂ may be in the range of 300 micrometers (μm) to 500 μm, or in the range of 250 μm to 800 μm. The Tx outer ground electrodes 112 and the Rx outer ground electrodes 122 may not sufficiently shield the OESC 124 from stray EM radiation that the EOSC 108 may emit in operation, as the stray EM radiation from the Tx portion 110 may extend into a space over the plane of the PIC. Accordingly, embodiments disclosed herein include a set of conducting pillars 221 and/or 222 that project from the Tx outer ground electrode 112 and/or the Rx outer ground electrode 122 to fence off the OESC 124 from the stray EM radiation that propagates outside of the main face of the chip, including the EM radiation emitted by the EOSC 108. These conducting pillars are electrically conducting and may be formed for example of a low-resistivity metal, such as for example copper (Cu), or a suitable metal alloy. The conducting pillars 121 or 122 form a three-dimensional (3D) ground cage, which extends out of a main face of the photonic chip 200 and encloses at least one of the OESC 124 and the EOSC 108.

FIG. 1A illustrates an example embodiment in which the EOSC 108 and the OESC 124 are aligned along an X-axis that is parallel to the Tx signal electrodes 114, and are disposed with the Tx signal electrodes 114 and the Rx signal electrodes 126 extending in parallel to each other. In other embodiments the EOSC 108 and the OESC 124 may be disposed in different positions and orientations relative to each other.

FIG. 1B illustrates an example layout of PIC 150 in which the OESC 124 is disposed facing a side of the EOSC 108. Furthermore, the OESC 124 is shown with a single signal electrode 126 by way of example, and may be in the form of a single-ended PD. The PD signal electrode 126 is oriented in this embodiments at 90° to the Tx signal electrodes 114; an orthogonal orientation of the Tx and Rx signal electrodes 114, 126 may be advantageous for reducing the Tx-Rx crosstalk. In other embodiments the relative position and orientation of the EOSC 108 and the OESC 124 may be different from those shown in FIGS. 1A and 1B.

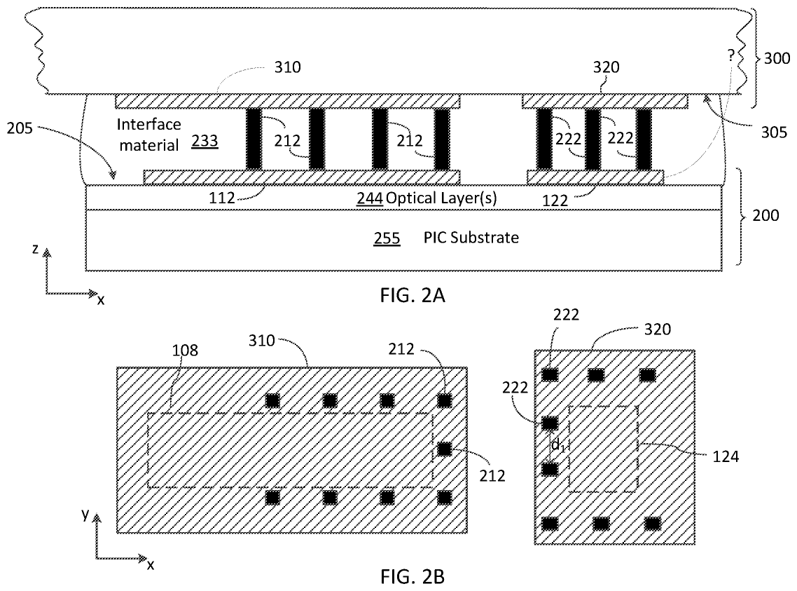

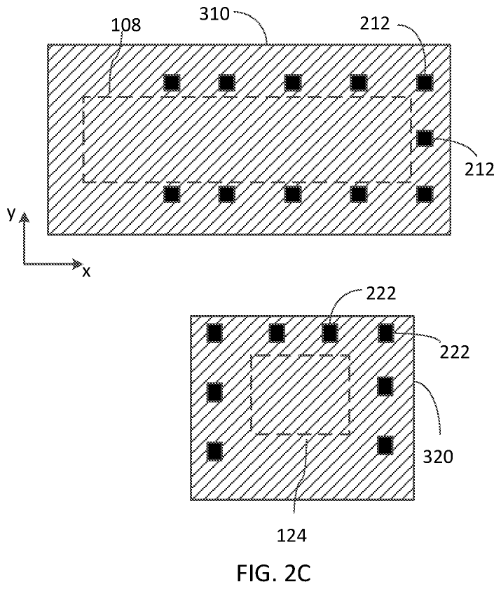

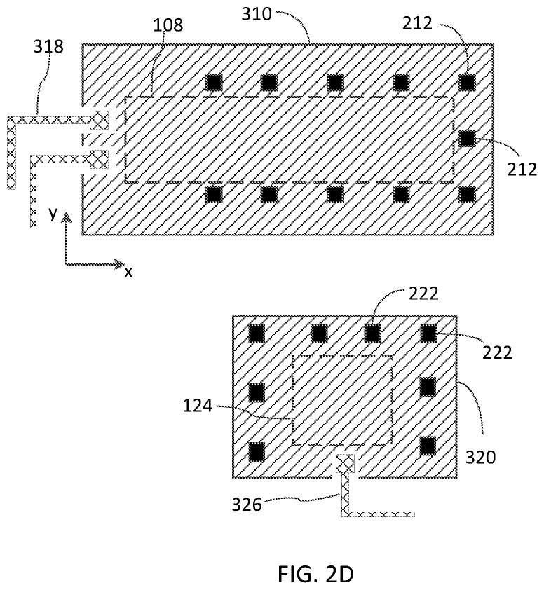

Referring now also to FIGS. 2A-2D, in some embodiments the photonic chip 200 implementing PIC 150 may be mounted to a carrier 300 so that a main face 205 of the photonic chip 200, where the PIC 150 is formed, faces the carrier 300, in a manner that may be referred to as a chip-flip mounting. The carrier 300 may provide support for the chip 200 and may also incorporate electrical circuitry 318, 326 for connecting to the contact pads 118, 126 of the EOSC 108 and the OESC 124 of the PIC. FIG. 2A schematically illustrates a side view of a portion of the optical transceiver device in the layout of FIG. 1A, generally showing the photonic chip 200 and the carrier 300 in a cross-section perpendicular to the main face 205 of the photonic chip 200. The photonic chip 200 may include one or more optical layers 244 supported by a substrate 255. The one or more optical layers are disposed at the main face 205 of the chip and used to implement PIC 150. The Tx ground electrode 112 and the Rx ground electrode 122 are disposed at or upon the main face 205 of the photonic chip, directly facing one or more top ground electrodes 31′0, 320 provided at a face 305 of the carrier 300 facing the photonic chip 200. The face 305 of the carrier 300 facing the photonic chip 200 may be referred to as the mounting face 305 of the carrier 300. The carrier 300 may be any suitable carrier, for example a ceramic carrier, such as but not exclusively a low-temperature co-fired ceramic (LTCC) carrier, or it may be of any other suitable material or materials.

In some embodiments the carrier 300 includes a first top ground electrode 320 and a second top ground electrode 310 that are formed at the mounting face 305 thereof. The first top ground electrode 320, which may also be referred to as the first carrier ground electrode 320, is disposed directly over the Rx ground electrode 122 to cover the OESC 124 from above the chip; this is illustrated in FIGS. 2B and 2C showing top ground electrodes 320, 310 of the carrier 300 in a plan view for the PIC layouts of FIGS. 1A and 1B, respectively. FIG. 2D also schematically shows a portion of electrical circuitry 318, 326, in the form of electrical signal pathways, that may be provided on the carrier 300 for connecting to the contact pads 118, 126 of the EOSC 108; this circuitry may include electrical transmission lines and various circuit elements as known in the art. In some embodiments the top ground electrodes 320, 310 and the electrical signal pathways 318, 326 may be provided in different layers of the carrier 300. The first top ground electrode 320 may be at least equal the OESC 124 in area; in some embodiments the first top ground electrode 320 may be at least equal in area to the Rx ground electrode 122, completely covering the Rx ground electrode 122 when viewed from above the main face 205 of the chip 200 through the carrier 300. Although the first top ground electrode 320 is illustrated in FIGS. 2B, 2C as being of a rectangular shape, this is not a requirement, and the shape of the first top ground electrode 320 may vary depending on an embodiment. The mounting face 305 of the carrier 300 is located at some distance l from the main face 205 of the photonic chip 200, with a gap 233 that may be filled by a suitable electrically insulating filler material, such as for example a suitable epoxy. By way of example, l may be in the range of 20 μm to 80 μm in some embodiments.

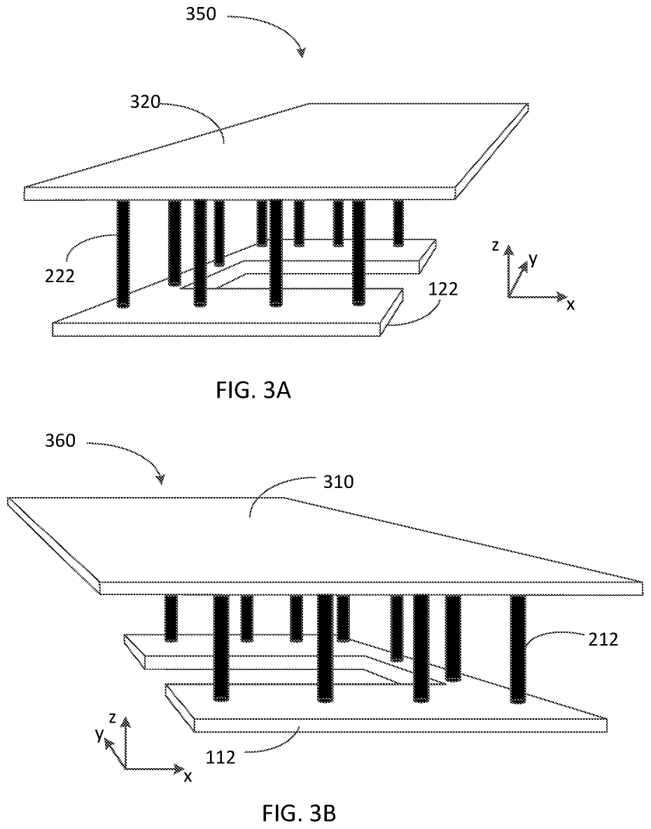

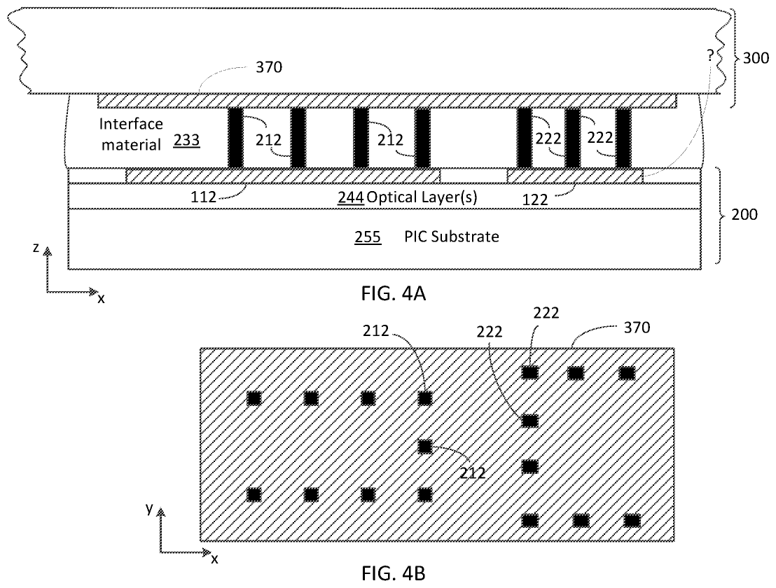

A first plurality of conducting pillars 222 may be provided to electrically connect the Rx outer ground electrode 122 to the first top ground electrode 320, forming a 3D ground cage 320 illustrated in FIG. 3A that at least partially encloses the OESC 124 from the sides and the top. The conducting pillars 222 extend from the Rx ground electrode 122, projecting generally perpendicularly thereto out of the plane of the PIC to connect to the first top ground electrode 320 of the carrier 300. The conducting pillars 222 are formed of an electrically conducting material or materials, such as a suitable metal. In some embodiments the pillars 222 may be made of copper (Cu). The pillars 222 may be successively arranged along at a least a portion of a circumference of the OESC 124 to form an EM fence, which at least partially surrounds the OESC 124 and shields it from stray EM radiation in an operating frequency range of the optical transceiver device, including the stray EM radiation that may be emitted by the EOSC 108. In some embodiments the pillars 222 may be disposed along at least half of the PD circumference to shield it from three sides including the side facing the EOSC 108. In some embodiments at least two of the pillars 222 may be disposed directly between the EOSC 108 and the OESC 124. The pillars 222 may be spaced by a first spacing d₁ that may be smaller than an RF wavelength Λ_{RF} in the operating frequency range of the transceiver, or smaller than Λ_{RF}/2. In some embodiments d₁ may be equal or smaller than Λ_{RF}/4. The first spacing d₁ between the pillars 222 may be selected so as to provide a target suppression of the EM interference from the EOSC 108; generally, the smaller is the distance d₁ between pillars, the better is the EM isolation they provide. By way of example, for a transceiver operating in the frequency range of 30 GHz-100 GHz the first spacing d₁ between the pillars 222 may be in the range of 0.1 mm to 0.5 mm, or more broadly in the range of 0.1 mm to 1 mm, depending on a tolerance level to the Tx-Rx coupling and the operating frequency range of the transceiver. In some embodiments the spacing d₁ between the pillars may be smaller than a width d₃ of a EOSC-facing portion of a PD embodying the OESC 124.

FIG. 3A schematically illustrates the 3D Rx ground cage 350 formed by the Rx outer ground electrode 122, the first plurality of pillars 222, and the first top ground electrode 320. The 3D Rx ground cage 350 encases the OESC 124, electromagnetically shielding the OESC 124, and a volume directly above the OESC 124, from stray EM radiation that may be emitted by the EOSC 108 in operation. The 3D Rx ground cage 350 thus protects the OESC 124 from stray EM radiation in three dimensions. The 3D Rx ground cage 350 may have an opening at a distal side of the OESC 124 facing away from the EOSC 108, or generally away from the Tx portion 110 of the PIC 150.

Referring back to FIGS. 2A-2C, in some embodiments the carrier 300 may have a second top ground electrode 310 formed at the mounting face 305 thereof. The second top ground electrode 310, which may also be referred to as the second carrier ground electrode 310, is disposed directly over the Tx outer ground electrode 112 to cover the EOSC 108 from the top; this is illustrated in FIGS. 2B and 2C showing the top ground electrodes 310, 320 of the carrier 300 in a plan view for the PIC layouts of FIGS. 1B and 1C. The second top ground electrode 310 may be at least equal in area to the EOSC 108, covering the signal electrodes 114 when viewed from above the carrier 300. In some embodiments the second top ground electrode 310 may be at least equal in area to the Tx outer ground electrode 112, covering it from the top. Although illustrated as being of a rectangular shape, this is not a requirement, and the shape of the second top ground electrode 310 may vary depending on an embodiment. A second plurality of conducting pillars 212 may be provided to electrically connect the Tx outer ground electrode 112 to the second top ground electrode 310 and to form an EM fence around the EOSC 108. The pillars 212 extend from the Tx outer ground electrode 112, projecting generally perpendicularly thereto out of the plane of the PIC. The pillars 212 are formed of an electrically conducting material or materials, such as metal. In some embodiments the pillars 212 may be made of copper (Cu).

The pillars 212 may be arranged in succession along at a least a portion of a circumference of the EOSC 108, at least partially surrounding the EO conversion region 111 and/or the signal electrodes 114 so as to prevent stray RF radiation emitted by the EOSC 108 from reaching the OESC 124. The pillars 212, when provided, may be disposed in a row along at least a portion of the Tx outer ground electrode 112 facing the OESC 124. In some embodiments at least two of the pillars 212 may be disposed directly between the EOSC 108 and the OESC 124. In some embodiments pillars 212 may be disposed in succession along at least half of the EOSC circumference to form an EM fence shielding the EOSC 108 at at least two sides, including the side closest to and/or facing the OESC 124. The pillars 212 may be spaced by a second spacing d₂ that may be smaller than the RF wavelength Λ_{RF} in the operating frequency range of the transceiver, or less than Λ_{RF}/2. The second spacing d₂ between the pillars may be selected so as to provide a target suppression of the stray RF radiation emanating from the EOSC 108 beyond an area delimited by the pillars 121. By way of example, for a transceiver operating in the frequency range of 100 GHz the second spacing d₂ between the pillars 212 may be in the range of 0.1 mm to 0.5 mm, or in the range of 0.1 mm to 1 mm.

The Tx ground electrode 112, the second top ground electrode 310, and the conducting pillars 212 electrically connecting them may form a 3D Tx ground cage 360 schematically illustrated in FIG. 3B. The Tx ground cage 360 may be generally similar in shape to the Rx ground cage 350 shown in FIG. 3A, but oppositely oriented. The 3D Tx ground cage 360 encases the EOSC 108, electromagnetically shielding the OESC 124 from stray EM radiation that may be emitted by the EOSC 108. The 3D Tx ground cage 360 formed with the pillars 212 may have an opening at a distal side of the EOSC 108 that is farthest away from the PD OESC, or generally from the Rx portion 120 of the PIC.

FIGS. 2A-2C illustrate embodiments with two separate carrier ground electrodes 310, 320 providing separate top conducting covers for the 3D Rx ground cage 350 and the 3D Tx ground cage 360, which may not be electrically connected at the carrier. In some embodiments the two top ground electrodes 310, 320 of the carrier 300 may be merged into one continuous ground electrode 370 covering an area of the PIC 150 including both the OESC 124 with the Rx ground electrode 122, and the EOSC 108 with the Tx ground electrode 112, as illustrated in FIGS. 4A and 4B for the PIC layout of FIG. 1B by way of example. The one continuous ground electrode 370 may provide a common top cover of the 3D Rx ground cage 350 and the 3D Tx ground cage 360. FIG. 4B schematically shows the carrier ground electrode 370, which may be referred to as the ground plane of the carrier, in a top view through the carrier. Although illustrated as being of a rectangular shape, this is not a requirement, and the exact shape of the carrier ground electrode 370 may vary depending on an embodiment.

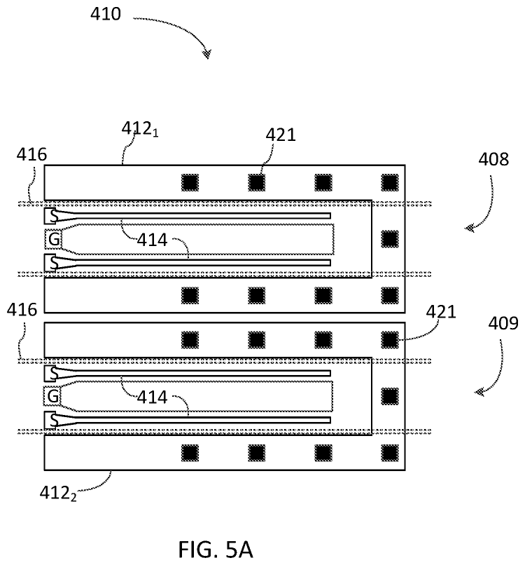

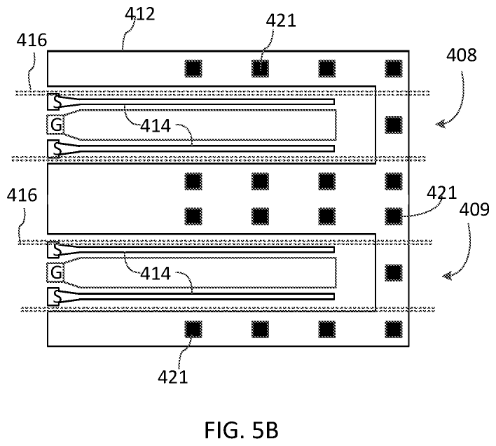

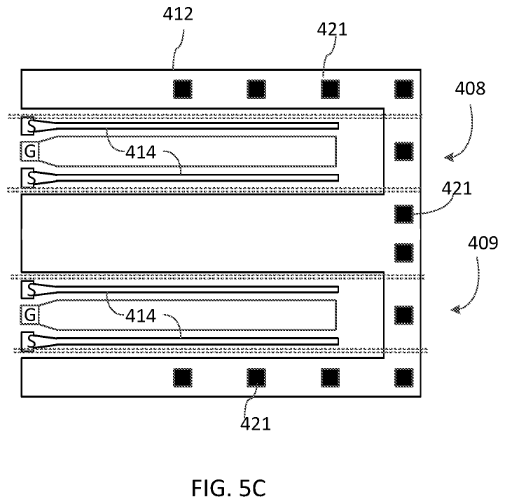

Referring to FIGS. 5A-5C, in some embodiments a Tx portion of a transceiver PIC may include two or more EOSCs, which may be commonly or individually shielded or “caged” as generally described above. FIG. 5A illustrates an example electrode layout of a Tx portion 410 of a transceiver PIC that includes two EOSCs, a first EOSC 408 and a second EOSC 409, that are separately “caged”, with each EOSC at least partially surrounded by a different “fence” of ground pillars 421, generally as described above with reference to the EOSC 108 and conducting pillars 212. The conducting pillars 421 may be also referred to herein as the conducting pillars 421 or simply as pillars 421. The EOSCs 408 and 409 may be embodied for example with two MZMs connected in parallel to form a nested MZM, which may be configured to operate as an optical IQ modulator. The first EOSC 408, which includes two upper signal electrodes 414 extending along two upper optical waveguides 416 and which may be configured for example to provide in-phase (“I”) optical modulation, is partially enclosed by a first Tx outer ground electrode 412₁. The second EOSC 409, which includes two lower signal electrodes 414 extending along two lower optical waveguides 416 and which may be configured to provide quadrature-phase (“Q”) modulation, is partially enclosed by a second Tx outer ground electrode 412₂. The two optical waveguides 416 in each of the EOSC 409 and 408 may represent two waveguide arms of a corresponding MZM.

In the embodiments of FIGS. 5A and 5B the pillars 421 are positioned to shield, or fence-off, the EOSCs 408, 409 from each other as well as to shield, or fence-off, an Rx portion of the transceiver PIC (not shown) from the EOSCs 408 and 409. A first set of conducting pillars 421 at least partially surrounds the first EOSC 408, projecting from the first Tx outer ground electrode 412₁ to connect to a top carrier ground electrode, as generally described above; a subset of the first set of pillars is disposed between the signal electrodes 414 of the first EOSC 408 and the signal electrodes 414 second EOSC 409 to provide an EM shield therebetween. A second set of ground pillars 421 at least partially surrounds the second EOSC 409, projecting from the second Tx outer ground electrode 412₂ to electrically connect to a same or different top carrier ground electrode, generally as described above. In some embodiments the second set of ground pillars 421 may also include pillars disposed between the signal electrodes 414 of the first EOSC 408 and the signal electrodes 414 of the second EOSC 409.

In the embodiment of FIG. 5A, the Tx outer ground electrodes 412₁ and 412₂ of the two EOSCs 408, 409 are spaced apart with a gap therebetween. FIG. 5B illustrates an embodiment wherein the outer ground electrodes of the EOSCs 408 and 409 are merged to form one Tx outer ground electrode 412 that is common to both EOSCs. The ground pillars 421 surrounding the first and second EOSC 408, 409 may connect to a same or different top carrier ground electrode. FIG. 5C illustrates an embodiment wherein the EOSCs 408, 409 share a 3D ground cage formed by a common Tx outer ground electrode 412 and a set of pillars 421 that partially surrounds the region of the PIC where the EOSCs 408, 409 are located, with no pillars between the EOSCs 408 and 409. In such embodiments the EOSCs 408, 409 may be commonly covered by a top carrier ground electrode.

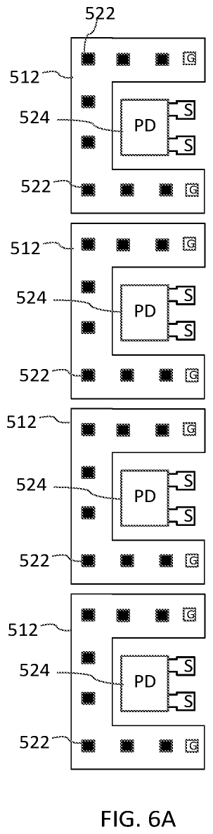

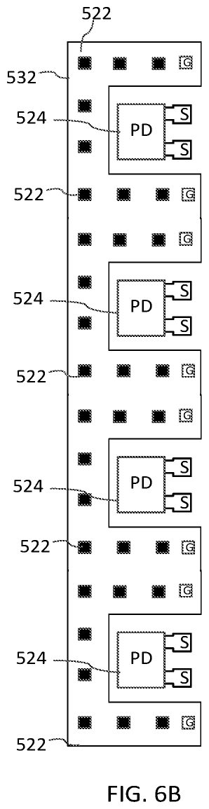

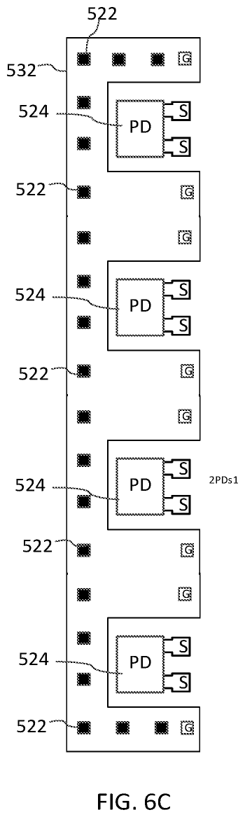

FIGS. 6A-6C illustrate example Rx ground electrode layouts in embodiments where an Rx portion of a transceiver PIC includes a plurality of PDs, each operating as an OE signal converter (OESC). In the examples shown in FIGS. 6A-6C, an Rx portion of a PIC chip includes four PDs 524, which in some embodiments may be coupled to outputs of a 90° optical hybrid (not shown) in a phase diversity receiver. In other embodiments the number of PDs in the Rx portion of the PIC chip may be different. FIG. 6A illustrate an embodiment wherein the PDs 524 are separately “caged”. A separate Rx outer ground electrode 512 at least partially surrounds each PD 524 in the plain of the PIC, with a separate set of conducting ground pillars 522 projecting from each Rx outer ground electrode 512 toward a top carrier electrode (not shown), generally as described hereinabove with reference to FIGS. 2A-4B. Each set of conducting ground pillars 522 effectively fences off one of the PD 524 from a Tx portion of the PIC chip (not shown), and from one or more adjacent PDs 524. The sets of conducting pillars 522 surrounding each PD 524 may connect to a same top carrier ground electrode that extends to cover all four PDs 524, or to a separate top carrier ground electrode. Each Rx ground electrode 512 is shaped to define an opening in which a PD 524 is disposed.

In the embodiment of FIG. 6A, the Rx ground electrodes 512 of the four PDs 524 are spaced apart with a gap therebetween. FIG. 6B illustrates an embodiment wherein the Rx ground electrodes of the four PDs 524 are merged to form one Rx outer ground electrode 532 that is common to the four PDs. The conducting pillars 522 individually surrounding each of the PDs 524 from three sides may connect to a same or different top carrier ground electrode. FIG. 6C illustrate an embodiment wherein the PDs 524 share a ground cage formed by a common Rx outer ground electrode 532 and a set of pillars 522 that partially surrounds the region of the PIC where the PDs 524 are located, with no pillars in-between. In such embodiments the PDs 524 may be commonly covered by a top carrier ground electrode. In the embodiments illustrated in FIGS. 6A-6C the Rx ground electrode or electrodes are shaped to define four different openings, in which the PDs are individually disposed. In other embodiments two or more PDs may share a same opening defined in an Rx outer ground electrode.

In some embodiments the ground electrodes of the carrier covering the OESC and/or the EOSC, such as the top ground electrodes 310, 320, 370, may be formed of a relatively thick metal layer to ensure a suitably low sheet resistance thereof and good EM isolation characteristics. By way of example, the top ground electrodes 310, 320, 370 may be formed of, or include, a copper layer that may be 300 to 500 μm thick, not excluding thickness outside of this range. The Tx ground electrodes 112, 412 and the Rx ground electrodes 122, 532 may be in the form of metal pads disposed over a main face of the photonic chip.

Advantageously, the 3D ground cages formed with conducting ground pillars and top carrier ground electrodes as described above enable reducing the Tx-Rx crosstalk in a frequency range of 10-50 GHz and beyond, by up to 10 dB or more in come embodiments, and may be fabricated using standard wafer-scale packaging technologies. The 3D Rx and/or Tx ground cages described above may also enable reducing the distance between the EOSC and the OESC on the chip, for example to as low as 300 μm in some embodiments, while meeting a target limit on the Tx-Rx cross-coupling. Furthermore, surrounding high-power optical modulators such as MZMs with low-conductivity metal pillars connected to a ground metal plane on the carrier provides an additional advantage of reducing a ground bouncing by a strong RF signal applied to the modulator.

The above-described exemplary embodiments are intended to be illustrative in all respects rather than restrictive, of the present invention. Indeed, various other embodiments and modifications to the present disclosure, in addition to those described herein, will be apparent to those of ordinary skill in the art from the foregoing description and accompanying drawings.

For example, it will be appreciated that different dielectric materials and semiconductor materials including but not limited to silicon (Si), Silicon on Insulator (SOI), and compound semiconductor materials of groups commonly referred to as A3B5 and A2B4, such as GaAs, InP, and their alloys and compounds may be used to fabricate elements of the optical transceiver example embodiments of which are described hereinabove. Furthermore in one or more embodiments the carrier ground electrodes 370, 320, 310 may be mesh-like rather than continuous, with the mesh size small enough to provide a suitable barrier for the stray EM radiation at the operating frequency of the device. Furthermore, in some embodiments the EO signal converters may include one or more MZMs with only one signal electrode in each modulator. Furthermore in some embodiments the EO signal converters may be embodied using integrated devices other than MZMs, including but not limited to other types of optical modulators, such as for example optical phase modulators or optical modulators based on micro-ring or micro-disk resonators, or as directly modulated lasers, or semiconductor-insulator-semiconductor capacitor (SiSCAP) modulators. Furthermore the conducting and conducting pillars 212, 222, 421, 522 described above are shown to have a square cross-section by way of example only, and may have differently shaped cross-sections, including but not limited to circular, oval, and rectangular. It will be further appreciated that the techniques and approaches to suppressing EM crosstalk and EM shielding, which are described above with reference to optoelectronic devices such as integrated OE signal converters and integrated EO signal converters, may also be applied to integrated electronic and optoelectronic devices and elements other than OE or EO converters. Furthermore, in some embodiments only one of the OECS or the EOSC of a transceiver PIC may be surrounded by conducting pillars and “caged”, when this is sufficient to provide desired Tx-Rx isolation. Furthermore, in some embodiments the Rx portion and the Tx portion of the transceiver may be disposed on different photonic chips. In some embodiments only one of the EO signal converter and the OE signal converter may be encased in a 3D ground cage of the type described hereinabove. For example, in some embodiments only the OE signal converter may be encased in a 3D ground cage.

Furthermore, elements or features described hereinabove with reference to a particular example embodiment may also be incorporated in other described embodiments or their variants. Furthermore, some of the elements described hereinabove with reference to one or more embodiments may be omitted or replaced with another elements capable of similar functions, and another elements added.

Furthermore in the description above, for purposes of explanation and not limitation, specific details are set forth such as particular architectures, interfaces, techniques, etc. in order to provide a thorough understanding of the present invention. In some instances, detailed descriptions of well-known devices, circuits, and methods are omitted so as not to obscure the description of the present invention with unnecessary detail. Thus, for example, it will be appreciated by those skilled in the art that block diagrams herein can represent conceptual views of illustrative circuitry embodying the principles of the technology. All statements herein reciting principles, aspects, and embodiments of the invention, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure. Furthermore, it will be appreciated that each of the example embodiments described hereinabove may include features described with reference to other example embodiments.

Thus, while the present invention has been particularly shown and described with reference to example embodiments as illustrated in the drawing, it will be understood by one skilled in the art that various changes in detail may be affected therein without departing from the spirit and scope of the invention as defined by the claims.

1. An optical transceiver comprising:
a photonic chip comprising a main face and a photonic integrated circuit (PIC) disposed at the main face, the PIC comprising:
a first optoelectronic device, and
a first PIC ground electrode at least partially surrounding the first optoelectronic device at the main face of the photonic chip;
a carrier to which the photonic chip is mounted, the carrier comprising a first top ground electrode disposed opposite the first PIC ground electrode with a gap therebetween, the first top ground electrode at least partially covering the first optoelectronic device; and,
a first plurality of conducting pillars projecting from the main face of the photonic chip and electrically connecting the first PIC ground electrode to the first top ground electrode, the first plurality of conducting pillars arranged to form a fence configured to provide a shield against stray electromagnetic radiation in an operating frequency range of the optical transceiver.

2. The optical transceiver of claim 1 wherein the first optoelectronic device is an opto-electric (OE) signal converter.

3. The optical transceiver of claim 1 wherein the first optoelectronic device is an electro-optic (EO) signal converter.

4. The optical transceiver of claim 1 wherein the fence formed by the first plurality of conducting pillars at least partially surrounds the first optoelectronic device on at least three sides thereof in a plane parallel to the main face of the photonic chip.

5. The optical transceiver of claim 1 wherein the first plurality of conducting pillars, the first PIC ground electrode, and the first top ground electrode form a three-dimensional (3D) ground cage over the first optoelectronic device.

6. The optical transceiver of claim 2 wherein the OE signal converter comprises a photodetector (PD) having a width at the main face of the photonic chip, and wherein the first plurality of conducting pillars comprises two pillars that are spaced apart by less than the width of the PD.

7. The optical transceiver of claim 1 wherein the first plurality of conducting pillars comprises two pillars that are spaced apart by less than 500 μm.

8. The optical transceiver of claim 1 wherein the first plurality of conducting pillars comprises two pillars that are spaced apart by at most one half of a wavelength of an RF signal in the operating frequency range of the optical transceiver.

9. The optical transceiver of claim 1 wherein the first top ground electrode at least covers the first optoelectronic device when viewed in a direction perpendicular to the main face of the photonic chip through the carrier.

10. The optical transceiver of claim 2 wherein the PIC further comprises an electro-optic (EO) signal converter, and wherein the first plurality of conducting pillars is arranged to electromagnetically shield the OE signal converter from the EO signal converter.

11. The optical transceiver of claim 10 wherein the first plurality of conducting pillars comprises at least two conducting pillars disposed along a portion of the OE signal converter facing the EO signal converter.

12. The optical transceiver of claim 10 further comprising a second PIC ground electrode at least partially surrounding the EO signal converter at the main face of the photonic chip.

13. The optical transceiver of claim 12 wherein the carrier comprises a second top ground electrode disposed opposite to the second PIC ground electrode, the optical transceiver further comprising a second plurality of conducting pillars connecting the second PIC ground electrode to the second top ground electrode and arranged to shield the OE signal converter from the EO signal converter in the operating frequency range of the optical transceiver.

14. The optical transceiver of claim 13 wherein the second plurality of conducting pillars at least partially surrounds the EO signal converter in a plane parallel to the main face of the photonic chip.

15. An optical transceiver comprising:
a photonic chip comprising a main face and a photonic integrated circuit (PIC) disposed at the main face, the PIC comprising:
an OE converter,
an EO converter;
a first PIC ground electrode disposed at the main face of the photonic chip at least partially surrounding the OE converter;
a second PIC ground electrode disposed at the main face of the photonic chip at least partially surrounding the EO converter;
a carrier to which the photonic chip is mounted with a gap therebetween, the carrier comprising one or more top ground electrodes disposed opposite the first and second PIC ground electrode, the one or more top ground electrode at least partially covering at least one of the EO converter or the OE converter;
a first plurality of conducting pillars electrically connecting the first PIC ground electrode to the one or more top ground electrodes to form a fence at least partially surrounding the OE converter to provide a shield against stray electromagnetic radiation in an operating frequency range of the optical transceiver; and,
a second plurality of conducting pillars electrically connecting the second PIC ground electrode to the one or more top ground electrodes to form a fence at least partially surrounding the EO converter;
wherein the second plurality of conducting pillars, the second PIC ground electrode, and the one or more top ground electrodes form a three-dimensional ground cage over the EO signal converter.

16. The optical transceiver of claim 13 wherein the EO signal converter comprises an optical modulator having a width at the main face of the photonic chip, and wherein the second plurality of conducting pillars comprises two pillars that are spaced apart by less than the width of the optical modulator.

17. The optical transceiver of claim 13 wherein the second top ground electrode at least covers the EO signal converter when viewed in a direction perpendicular to the main face of the photonic chip through the carrier.

18. The optical transceiver of claim 13 wherein the first top ground electrode is separate from the second top ground electrode.

19. The optical transceiver of claim 13 wherein the first top ground electrode and the second top ground electrode are merged to form one top ground electrode.

20. The optical transceiver of claim 1 further comprising an insulating filler disposed between the carrier and the photonic chip and surrounding the first plurality of conducting pillars, wherein the carrier comprises a low-temperature co-fired ceramic (LTCC).
